(19) United States
(12) Patent Application Publication
(10) Pub. No.: US 2008/0052090 A1
(43) Pub. Date: Feb. 28, 2008

(54) Method and Device for the Individual, Location-Independent Designing of Images, Cards and Similar

(76) Inventors: Jens Heinemann, Berlin (DE); Birgit Dolde, Berlin (DE)

Correspondence Address: Blakely, Sokoloff, Taylor & Zafman, 12400 Wilshire Boulevard, 7th Floor, Los Angeles, CA, 90025, US

(21) Appl. No.: 10/570,917

(22) PCT Filed: Aug. 24, 2004
(86) PCT No.: PCT/DE04/01901

§ 371 Date: Feb. 12, 2007

(30) Foreign Application Priority Data
Sep. 4, 2003 (DE) 103 41 225.5

(51) Int. Cl. G06Q 30/00; B41J 2/315; G03B 17/53; G06F 3/02; G09F 13/00; H02J 7/00; G08B 13/00; G06F 3/033; G06F 3/041

(52) U.S. Cl. 705/1; 320/101; 340/541; 340/571; 345/161; 345/173; 347/171; 348/207.1; 40/124.02

(57) ABSTRACT

The invention relates to a method and an apparatus for the individual, location-independent design of pictures, cards and similar items, especially postcards. In contrast to conventional methods, systems and appliances for creating cards, photos and similar items, the invention creates the possibility of viewing and selecting the virtually finished product created individually by the user; only after this is the payment and output function activated. The method according to the invention is furthermore characterized by the integrated method for portrait recording by means of a video stream.

The invention relates to a method and an apparatus, respectively an interactive automated machine for the individual, location-independent design of pictures, cards and similar items, especially postcards.

Photographic machines for the production of passport photos in department stores or at airports and railway stations are already known. These machines usually consist of a booth in which a camera is present along with a seat for the person of whom the said person wants a passport picture to be made. Such stationary machines offer the opportunity to make passport photos simply at locations where there is a lot of business from passers-by.

These simple photographic machines have been have been followed by devices which make it possible for the user to combine a portrait with an existent picture already stored in the machine in order to form a photomontage.

GB 2 242 592 A describes a method and an apparatus which makes it possible for a picture taken by a video camera to be combined with stored motifs into a photomontage. According to this, after selection of a background motif, a picture which has just been taken is arranged in its foreground. For each of the stored background motifs there is a position at which a picture which has just been taken can be inserted. These predefined positions are preferably relatively unimportant portions of the selected background picture. Pictures combined in this way can be printed as a single picture by an apparatus as specified in GB 2 242 592 A.

In GB 2 270 605 A improvements are disclosed related to the montage of video pictures just taken with pictures already stored. These improvements relate in particular to simplifications of the operation by the user of an apparatus suitable for photomontage. Such simplifications are especially achieved by automation of the operation process. This is intended to make it possible for the user to insert text or edit the photomontage as well.

In DE 692 23 976 T2 a quick automated photo machine including video processing is disclosed. An automated machine such as this is intended to give the user a very high degree of control over picture design. In addition, the quality of the printed pictures is meant to be improved by using a wet photographic printing process.

The automated machines known from the prior art either disclose very simple methods for combining stored pictures with pictures just taken, whereby the quality of the prints is generally inferior, or priority is given to producing high quality portrait or passport pictures. In addition the user is meant to be offered a maximum of manipulation options during photomontage so he can get a picture he wants.

There are also devices for producing fun pictures and business cards; these are outfitted with casters and, in this manner, feature at least a slight degree of mobility. Known “photo vending machines” have a bulky design due to their technical equipment and the resulting heavy weight, and are designed primarily just for stationary use; such photo vending booths are equipped with a booth featuring visual and anti-glare screening provided by curtains and drapes.

Such devices are not suitable for use at locations which are touristically interesting but which can only be accessed with difficulty. But it is precisely this possible use which would be desirable since such an automated photo machine would make it possible for tourists, for example at souvenir shops where an interest in buying a souvenir is aroused in any case, to compose an individualized and, if desired, a location-related picture as a souvenir or greeting.

In addition, it would be desirable to have a machine available which not only can create and produce pictures with a self-selected motif at any location, but which can also be used for creating postcards and pictures which are accessible to a broad scope of applications.

Starting from this prior art, the object of the current invention is to create a method for designing cards individually, especially postcards, pictures and similar applications, from given pictures which are already stored and/or have just been taken, as well as to create an apparatus which can be deployed at any location to perform the method. In this context, both the method as well as the apparatus are intended to be suitable for the creation of an individual picture which permits the user a maximum of design and individuality, without restricting the mobility of the apparatus which assures deployment at any location. So the goal of the invention is creation of a multifunctional, easily operated, mobile system, which, even while avoiding visual screens, is suitable for the creation of high-quality pictures and other, similar applications.

In regard to a deployment potential of a video-photo machine which is as versatile as possible, it should accordingly feature a construction with optimized weight and dimensions as small as possible so as to permit its deployment at any location. Furthermore, such a machine should also be easy to maintain.

As used in the invention, the term “pictures, cards and similar items” is understood to include postcards, decals, printed paper covered with pictures, stickers, graphic files (in digital format (JPEG, Bitmap etc.)) and all application forms which are suitable for taking, storing, embedding and printing pictures.

As used in the invention, the term “location-independent” is not only understood to mean that the apparatus according to the invention need not be directed towards specific objects in order to be able to include these in the design of the final picture, it also means that the apparatus according to the invention is light-weight and, as desired, can also be moved several times a day without any special preparations and can thus be deployed at any location. The deployment location has no influence on the operability of the apparatus.

In reference to this invention the term “digital storage media” includes all currently known media which are suitable for storing digital information, especially so-called multimedia data (pictures, etc.). These can also be devices such as MP3 players, cellular phones, USB sticks or PDA's which have storage units and can interact with other devices either via a cable or wireless, for example using infrared or Bluetooth technology. As used in this invention the term also includes future media and storage units with the same purpose.

In connection with the invention at hand the term “wireless” denotes that communication between two devices which is possible without connection by a cable, i.e. by electromagnetic waves such as infrared, radio, Bluetooth MMS, UMTS and W-LAN.

The object is achieved by the characterizing features of the independent claims.

According to the invention a method which is characterized by the following features is envisaged, namely:
a) the application is explained to the user on a preview window on a screen,
b) whereby a language and communication selection can be activated, and
c) whereby the user then selects the picture or card motif from standard motifs kept in the system and/or from motifs provided by the user himself and embeds it in a layout,
d) whereby a portrait recording of the user is taken and embedded in the layout, and
e) as desired, an individual or standard greeting and message text is created by the user and integrated into the layout,
f) the ready-to-output product on the screen, which can be printed and/or sent and/or stored, is controlled by the user and, as desired, is accepted or else is edited and corrected by repeating at least steps c) to e) of the method,
g) at which point the payment and billing function is then started,
h) and finally the finished product is outputted.

When the method is completed the user still has the option of obtaining additional products or of repeating the action, whereby a memory effect, respectively, a shopping cart function of the system (Session ID) according to the invention is understood. An online networking of the system according to the invention with a server which, on the one hand, links several such systems together and connects these with one or more databases and on the other hand also stores and administers the stored protocols and “shopping carts” of the users, is also conceivable.

The invention, in contrast to conventional methods, systems and installations for the creation of cards, photos and similar items, offers the option of viewing and selecting the virtually finished product individually created by the user; only after this is the payment and output function activated. With conventional systems the user pays in advance and is generally not satisfied with the motifs created and therefore has to make an additional payment to create new motifs again.

The method according to the invention is also characterized by the integrated process of a portrait recording using a video stream. When a portrait is shot, the decisive moment of the shutter release is extremely important. If, for example, the eyes are momentarily closed, the mouth is in a frown, or the facial expression is unintended, this has lasting effects on the snapshot. A few details decide the success or failure of a good portrait photo. Snapshots with digital cameras using system-related delayed shutter release often turn portrait photography into a game of chance. The method according to the invention is based on a video stream which greatly simplifies the creation of a successful portrait so that even the unpracticed can achieve outstanding results. In contrast with the conventional method, not just a single shot is made, but a video stream is recorded. The format used for this is the digital video format. In this case the scan lines are recorded sequentially without interlacing (progressive recording mode). By means of this progressive recording the stream consists of a series of entire frame images.

The remaining process can be automated or have a manual design.

With manual design, depending on the length of the recorded video stream all the individual pictures can be shown to the user for selection or the user can be offered an interaction element (button, joystick, wheel etc) with which he can look for the best expression in the video stream.

With automatic design, photos blurred by motion are automatically sorted out and the user is only offered the sharpest pictures to choose from. The system is based on the fact that sharp pictures contain more information than pictures which are out of focus and blurred. When these pictures are compressed, for example in the JPEG format, the sharp individual pictures are characterized by larger file sizes because they contain more information. Recording a video sequence requires constant light.

For this purpose use is made of white LEDs whose light is evenly distributed in the range of the camera through a lens. In addition, by using LEDs power consumption can be greatly reduced. Less energy consumption also means less heating up. What's more, the lifetime of an LED is much longer than that of a conventional lamp. For these reasons, according to the invention the user, of whom a video stream is created, is illuminated with constant light by means of white LEDs. Regardless of whether the user makes his choice of pictures manually or automatically, the user is given a choice of at least 4 pictures from the video stream created.

Another special feature in contrast to conventional machines is that the user is displayed on the preview monitor as in a mirror. This means the user sees his mirror image in the monitor: if for example the head is moved “to the right”, then the head displayed on the monitor is also shown moving “to the right”. Conventional devices do not display such a mirror image; they display things the other way around.

Further characteristics and special features of the method according to the invention are as follows:

The user is shown a preview of the shot of the camera on the monitor in real time which he can vary by changing his position and/or other persons or objects, or the position of the camera, until a desired setting has been found.

To create a portrait recording a video stream is generated, whereby the (at least four) sharpest pictures are automatically presented (see above).

The fixed shot is displayed on the monitor inside a mask which shows a preview of the card, picture or similar item to be created.

The layout is adjusted automatically as far as possible by integrated software, but the user can also adjust the size and position of the shot by himself within a grid into which the mask is subdivided.

The user is presented a large number of motifs which he can select from to create his individual application. A preferred variant of the method according to the invention envisages that not only pictures stored in the system can be used, but the user can use the interface to establish a connection with the apparatus and in this way a motif stored on a storage medium of the user can be read out and used. Transfer of the motif during the performance of the method according to the invention is also possible wireless if the apparatus is correspondingly equipped. The selection of motifs shown, from which the user can make his selection while performing the method, is displayed arranged by themes in a preferred embodiment of the method. Therefore this can involve motifs which are kept on an internal storage medium which the user himself brings with him on a storage medium (e.g. USB stick, cellular phone etc.). The system has one or more interfaces for this purpose so that communication can be established between the user's medium and the installation. It is also conceivable that the motifs come from an online system and are downloaded from the internet from one's own or someone else's website or from an online database of a services provider. The user chooses from the selection at least one standard motif or one of his own motifs and transfers it into the layout, whereby the selected or transferred motif is also presented to the user within the mask. The layout is adjusted automatically and/or by the user in terms of the size and position of the standard or transferred motif, which is also arranged in the desired position within the grid of the mask. The action of choosing the picture can be repeated and corrected.

The postcards or pictures or similar items created and produced with the system according to the invention can, without any additional effort, be used many times over. The user chooses the type and manner of the output of the picture, card or similar item just created, perhaps, for example, as a hardcopy printout or as a postcard via an integrated printer or as an e-mail, or by saving to a storage medium he himself has brought with him or to an online database which, as necessary, he can still access later. The method according to the invention can thus be designed so that the user can transfer the card, picture or similar item composed by him to a digital storage medium connected to the interface of the apparatus. If the apparatus is designed for wireless communication, at the end of the method according to the invention the individually composed card can also be transferred to a mobile or stationary storage medium by using suitable methods.

Using the keyboard and/or the touch-screen monitor the user can also, if he wishes, create an individualized greeting and message text and integrate it into the layout; it is also possible to select standard texts. Thus the picture created in this way can also be sent immediately as a holiday greeting (electronically) or even “physically”, as a postcard.

For this purpose the system is also optionally equipped with a franking unit so that ready-to-mail postcards can be created.

The payment and invoice function, which supports payment by cash, credit card and other common means and options of payment, is started automatically when the selection procedure has been completed and the product is ready for output. Depending on the embodiment of the apparatus according to the invention for the performance of the method according to the invention, money is supplied by inserting cash in the form of coins and/or notes or by reading in an EC or credit card or even coupons. For an apparatus capable of wireless communication, payment for the performance of the method according to the invention can also be made wireless, for example by wireless invocation of appropriate services for direct debit from the user's bank account of the amount to be paid.

After payment, the product is outputted in accordance with the output options described above.

Upon completion of output, the system is reset to its initial state. During initial state, it is possible for advertising messages to be displayed on the screen, which is preferably a touch screen.

The two outer sides of the machine can also be used as advertising spaces, in particular either as background-illuminated display or as electronic advertising panel which is controlled by the internal DP system.

The invention also provides for an apparatus which has at least the features given immediately below for performing the method according to the invention:
A monitor. The monitor of the machine has the preferred embodiment of a touch-screen monitor. In this case, further means by which the user can make entries to control the machine are redundant. Besides the picture taken by the camera, when a touch-screen monitor is used correspondingly labeled fields for operation are displayed on it as well.
A camera with an adjustment apparatus. The camera of the machine according to the invention is preferably a digital video camera or at least a recording unit which is suitable for recording and forwarding pictures. What is envisaged here is a video camera which makes it possible to record, generate and edit a video stream and which displays a mirror image preview picture. As already described in detail above, in this way the user is presented with optimized and optimum pictures to choose from (manually or automatically). The user is preferably only presented with the (preferably four) sharpest photos. This is realized by means of an automatic filter—described above—which selects the four largest pictures in terms of volume. This assures that the picture currently being recorded by the camera is always precisely the one being displayed on the monitor. An adjustment unit can point the camera at the user.
A lighting unit. The invention provides in particular for a lighting unit of the user's (see above) consisting of LEDs. The invention also provides for the lighting unit of the machine to contain a photometer. The photometer assures that the lighting conditions in the range of the camera can be adjusted to the lighting of the object or person to be photographed.
Means for operating the machine. Independently of whether the machine according to the invention has a touch screen, there are means for operating the machine which can depend on the embodiment and which make it possible for the user to make entries for operation and control. However, for the machine to be as easy to operate as possible, these means should be confined to the most necessary means or operating elements. Provision has been made for a keyboard or a joystick, or a track-ball, or a touchpad etc.
At least one interface for communicating with external storage media and internet connection. One preferred embodiment of the machine according to the invention provides for an interface suitable for connecting to various digital storage media (USB stick, handhelds, iPOD, etc.). It is furthermore envisaged that these interfaces are also suitable for wireless interaction with mobile devices to permit data transfers. An internet connection of the apparatus is likewise envisaged. For one thing, this enables connection with external servers on which motifs are stored and can be selected; and, for another, it enables storage of self-created motifs on just such external servers. The pictures/motifs can be obtained from databases via radio or cable from another server per internet-based protocol or they can reside on one's own servers (VPN, private network).
An integrated DP system which in turn comprises at least one internal storage unit. The internal EDP system can be a client which is fed by a central (cluster) server or accesses external data sources per internet-based protocols.
An output apparatus for creating the pictures and/or cards or similar items. This means primarily a printer, preferably a color printer. The cards or pictures generated by the machine are preferably generated by a thermosublimation printer and coated directly after being printed with a UV-resistant, transparent foil. But there are also other conceivable and envisaged printing processes for printing a color card and possibly coating it with a protective foil. Moreover, with the output apparatus it is also understood that there is not only hardcopy output but also output in some other, possibly digital medium. The picture created can be sent by radio or cable per internet-based protocol to all media capable of displaying it, e.g. cellular phone display, monitor, etc.
A payment unit. Payment can be effected by fairly well known means of cash payment, by credit card payment or by online payment system.
A power supply. In addition to built in power sources as an energy source, supply of the machine according to the invention with electricity can also be additionally supported by a solar module (on the top side of the apparatus). When the machine is in stand-by-mode and thus only consumes a very low amount of energy, the energy generated by the solar module can be used to load the re-chargeable batteries. A conventional power supply via a cable is, depending on the embodiment, also envisaged. Such a power supply depends on the individual location of the apparatus according to the invention.
Means for mobility of the machine for location-independent placement. A special characteristic of the apparatus according to the invention is the mobility of the entire apparatus. For a machine according to the invention to be mobile, provision is not only made for a weight-optimized construction (for example, light metal, suitable plastics), but also for means for moving it such as wheels or casters and, as appropriate, handles which fold out or are hung.
Anti-theft protection. Such a mobile machine can, for one, be secured against theft by means which permit physical attachment of the apparatus at the individual location. For another, the machine according to the invention can also be equipped with a theft alarm system which is suitable for generating acoustic and/or visually perceptible signals. As another assurance against prohibited removal of the machine, a radio warning can signal an unforeseen change in the position of the device and thus provide monitoring.
A remote maintenance unit. The machine according to the invention should, however, not only be as simple as possible for the user to operate, it should also be as simple as possible to maintain. For this purpose remote maintenance, wireless communication means have been integrated. In addition, a data cable connection can also be available for remote maintenance. With these connections it is possible to query the status of the machines and thus solve specific problems or query the need for consumables which must be replaced or to make system updates (update function) or to load new pictures and forms or to provide access to external servers. In addition, this connection will be used for the transfer of data related to card payment procedures. Consequently, the internet connection already described (also wireless, as desired) is also used for such purposes. These facilities with remote maintenance abilities are new. The possibility of wireless maintenance and upkeep also makes the advantages of location-independence available to maintenance.

An interactive machine according to the invention can also feature a motion detector which detects the approach of people. This makes it possible for the machine to switch, all by itself, from a stand-by mode into function mode when potential users approach. In addition, a motion sensor can also be used to point the camera automatically at the user or to activate other functional processes of the apparatus.

Provision has also been made for the machine according to the invention to be used for the creation and output of postcards and, for this purpose, to be equipped with a franking machine. Within the scope of the invention the franking machine can be a franking unit which is capable of and suitable for outputting an unforgeable code, for example for an online connection which is set up similarly to the card payment procedure. Thus, it can involve DP franking. This not only makes it possible for the user to create an individual card, he can use this card immediately and also send it directly as a postcard without any additional effort. The machine is designed in such a way that it can change the postage depending on the destination which, according to appropriate input from the user, the postcard is supposed to reach.

Independently of this, a postcard can also be sent, as described above, by e-mail and/or by W-LAN.

The invention also envisages that the outer sides of the machine can be used as advertising spaces. For this purpose the outer sides of the machine are equipped with a background-illuminated display and furthermore, or alternatively, with an electronic advertising panel which is controlled, for example, by the DP system.

Further advantageous measures are contained in the dependent claims. The apparatus according to the invention is shown in the context of an example of an embodiment and described below; it shows:

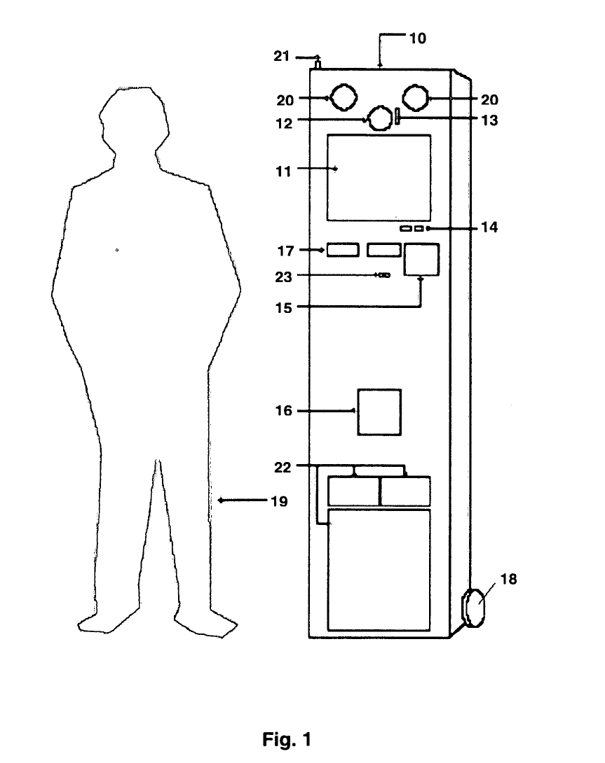

FIG. 1 a schematic view of the interactive machine according to the invention;

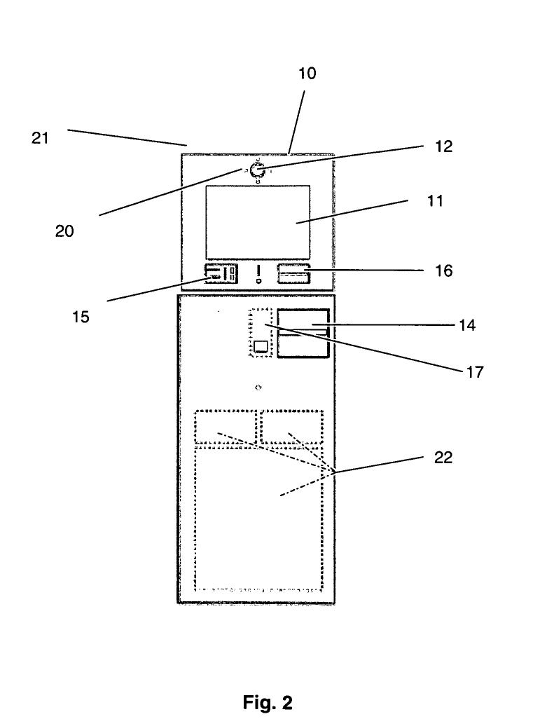

FIG. 2 another view based on FIG. 1, with video camera and LED

FIG. 1 shows an interactive machine 10, consisting of an essentially vertical, rectangular, compact outer housing which contains the individual components of the system. Other embodiments are conceivable and not excluded.

A monitor 11, preferably a TFT touch-screen monitor, is positioned at the eye-level of a user 19. Over it a camera 12 is arranged with the adjacently positioned LED 20 and an adjustment apparatus 13, which should preferably be more or less at eye-level of the user. Using the adjustment apparatus 13 the camera can be pointed at the face of the user 19; it is controlled via the monitor 11. For additional operation, besides the functionalities of a touch screen, a keyboard 14 (schematically outlined) is also envisaged, which is kept small in the context of this embodiment example.

Using the keyboard 14 and/or the touch-screen monitor 11, the user 19 can, if he wishes, also create an individual greeting and message text and integrate it into the layout; it is also possible to select standard texts.

Using an apparatus for establishing communication with external storage media 17, the user 19 can connect an external peripheral device, e.g. a USB stick, a handheld or the user's own digital camera with pictures stored on it, via a USB interface or a cellular phone or a similar device via an interface for wireless connection (e.g. Bluetooth). Later, via this interface, the finished picture, postcard, etc., as desired, can also be outputted or stored at the desired location.

Furthermore, on the housing of machine 10 an apparatus for wireless connection (WLAN/GSM/radio), for example an antenna 21 (other embodiments for the same purpose are however also conceivable), is envisaged, for example for the purposes of remote maintenance, a system update, control, radio warning of damage or theft, the internet connection etc. The payment apparatus 15 is equipped with various slots for handling common means of payment (monetary notes, coins, credit cards, coupons, etc.) (schematically outlined). The hardcopy of the product created by the user is ejected via an output shaft 16. A franking unit (not shown) is envisaged within machine 10.

Furthermore, appliances 23 for detecting approaching people (proximity sensors) are envisaged on the outer side of the machine 10 which, when they detect approaching people, can, as desired, switch the machine 10 from standby mode into functional mode automatically.

FIG. 2 also shows, arranged around the camera, the 4 LED diodes which supply the lighting and illumination of the user 19. Camera 12 in FIG. 2 is in this case a digital camera suitable for recording video sequences (video stream).

The data processing unit 22 and data processing components are arranged inside the housing.

The machine 10 is designed to provide mobility with wheels 18 and, if desired, also (not shown) with carrying handles or similar devices.

### REFERENCE NUMBERS

10 Interactive machine

11 Monitor

12 Camera

13 Adjustment apparatus

14 Keys

15 Payment apparatus

16 Output shaft

17 Apparatus for communication apparatus with external storage media (slot/interface)

18 Wheels

19 User

20 LED

21 Antenna (GSM/WLAN/radio)

22 Data processing unit

23 Proximity sensor

1. Method for creating individual pictures, cards and similar items comprising at least the following steps
(a) the application is explained to the user on a preview window on a screen,
(b) whereby a language and communication selection can be activated, and
(c) whereby the user then selects the picture or card motif from standard motifs kept in the system and/or from motifs supplied by the user himself and embeds in a layout,
(d) whereby a portrait recording of the user is created and embedded in the layout, and,
(e) as desired, an individual or standard greeting and message text is created by the user and integrated into the layout,
(f) the ready-to-output product on the screen, which can be printed and/or sent and/or stored, is controlled by the user and, as desired, is accepted or else is edited and corrected by repeating at least steps c) to 3) of the method,
(g) at which point subsequently the payment and billing function is then started,
(h) and finally the finished product is outputted.

2. Method for creating a portrait recording, especially for creating individual pictures, cards and similar items according to claim 1, whereby by means of a digital video camera a sequence of pictures of the user is recorded and, in this manner, a video stream is generated and the best picture is selected either manually or automatically.

3. Method for creating a portrait recording according to claim 2, whereby the format used is a DP stream in progressive recording mode.

4. Method for creating a portrait recording according to claim 2, whereby for manual selection the individual pictures are offered to the user and the best picture is selected by the user.

5. Method for creating a portrait recording according to claim 4, whereby the user is offered an interaction element for selecting an individual picture.

6. Method for creating a portrait recording according to claim 2, whereby during the automatic selection photos blurred by movement are discarded and the user is only offered the sharpest pictures for selection.

7. Method for creating a portrait recording according to claim 2, whereby the user of whom a video stream is generated, is illuminated with constant light by means of white LEDs.

8. Method for creating a portrait recording according to claim 2, whereby the user is offered at least 4 pictures of the generated video stream to select from.

9. Method for the creation of a portrait recording according to claim 2, whereby the picture or pictures are displayed to the user as a mirror image of the user on a suitable monitor as a preview.

10. Method according to claim 1, whereby the completely created picture, card or similar item is outputted as hardcopy print-out or as postcard via an integrated printer or as an e-mail or by saving to a storage medium which the user has brought with him (e.g. a screen saver on the cellular phone, PDAs or similar devices) or by saving to an online database offered by the system.

11. Method according to claim 1, whereby the storage media for creating individual layouts with stored motifs or for storing the finished composed pictures, cards and similar items are selected from external stationary or mobile storage media or online databases.

12. Method according to claim 10, whereby corresponding interfaces are envisaged for transfer by means of internet or wireless connection or external peripheral devices.

13. Interactive machine for the individual design of pictures, cards, especially postcards and similar items, comprising at least
one monitor,
one camera with an adjustment apparatus,
one lighting unit,
means for operating the machine,
at least one interface for communication with external storage media and internet connection,
one integrated DP system which in turn comprises at least one internal storage unit,
one output apparatus for creating the pictures and/or cards,
one payment unit,
one power supply,
means for mobility of the machine for location-independent placement.
anti-theft protection,
one remote-maintenance unit.

14. Machine according to claim 13, whereby the camera involves a digital video camera for generating a video stream.

15. Machine according to claim 13, whereby the lighting unit features a photometer and several LED diodes for generating constant light.

16. Machine according to claim 13, whereby the monitor is a touch-screen monitor.

17. Machine according to claim 13, whereby the means for operating the machine are a keyboard and/or a joystick.

18. Machine according to claim 13, whereby the output unit is a thermosublimation printer.

19. Machine according to claim 13, whereby the interface is suitable for various digital storage media.

20. Machine according to claim 13, which also features, in addition to the conventional power supply, solar modules for generating solar energy and/or recharging batteries.

21. Machine according to claim 13, whereby the means for movement are wheels or casters or appliances for carrying.

22. Machine according to claim 13, whereby the theft prevention means permit physical attachment of the apparatus at the individual location and/or emission of signals which are perceptible acoustically, visually and/or via radio.

23. Machine according to claim 13, whereby for remote maintenance wireless communication means are integrated, or data cables are available.

24. Machine according to claim 13, whereby it features a franking unit.

25. Machine according to claim 13, whereby it features a motion sensor suitable for the detection of approaching people.

26. Machine according to claim 13, whereby the outer sides of the machine serve as advertising spaces and are designed as a background-illuminated display and/or as an electronic advertising panel.
